(19) United States
(12) Patent Application Publication
(10) Pub. No.: US 2006/0227385 A1
(43) Pub. Date: Oct. 12, 2006

(54) Image processing apparatus and image processing program

(75) Inventor: Yukihiro Kawada, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/401,386

(22) Filed: Apr. 11, 2006

(30) Foreign Application Priority Data
Apr. 12, 2005 (JP) 2005-114988

(51) Int. Cl. H04N 1/23

(52) U.S. Cl. 358/302

(57) ABSTRACT

The present invention provides an image processing apparatus comprising: an image input device; an image display device; a face area detection device which detects a face area of a person in the image by analyzing the image; an individual face display file generation device which generates an individual face display file for displaying the trimmed face area by trimming the detected area; a link destination information acquisition device which acquires the link destination information indicating a storage location of the individual face display file; a link destination information embedding device which embeds the link destination information for the individual face display file corresponding to the face area in the selected area including the detected area in the image; an instruction device which instructs a desired position in the image; and a display control device which displays the individual face display file corresponding to the face area within the selected area.

### BACKGROUND OF THE INVENTION

1. Field of the Invention

The present invention relates to an image processing apparatus and an image processing program, and more particularly to an image processing apparatus and an image processing program for detecting a face area from an image.

2. Description of the Related Art

Conventionally, the techniques for detecting the face area of the person photographed in the image have been developed. For example, a video signal processing apparatus for detecting a skin color area or the face area of the person from a video signal and correcting the detected area alone has been disclosed in Japanese Patent Application Laid-Open No. 11-146405. Also, an image processing method for providing an image in which if the image data has a characteristic part such as a part of the face of the person, it is not processed, or minutely processed, but its peripheral or other parts are edited in a desired drawing pattern without feeling odd has been disclosed in Japanese Patent Application Laid-Open No. 2004-282664 (paragraph [0040]).

### SUMMARY OF THE INVENTION

However, the video signal processing apparatus as disclosed in Japanese Patent Application Laid-Open No. 11-146405 corrects only the face area detected from the original image, and was unsuitable for the management or reproduction display of the image taking notice of the face area. Also, the image processing method as disclosed in Japanese Patent Application Laid-Open No. 2004-282664 extracts the face area from the original image, and edits and re-synthesizes the peripheral part, and was still unsuitable for the management or reproduction display of the image taking notice of the face area.

This invention has been achieved in the light of the above problems, and it is an object of the invention to provide an image processing apparatus and an image processing program in which the image can be easily processed to be suitable for the management or reproduction display of the image taking notice of the face area of the person photographed in the image.

In order to accomplish the above object, according to a first aspect of the present invention, there is provided an image processing apparatus comprising an image input device which inputs an image, an image display device which reproduces and displays the image, a face area detection device which detects a face area of a person photographed in the image by analyzing the image, an individual face display file generation device which generates an individual face display file for displaying the trimmed face area by trimming the detected face area, a link destination information acquisition device which acquires the link destination information indicating a storage location of the individual face display file, a link destination information embedding device which embeds the link destination information for the individual face display file corresponding to the face area within a selected area in the selected area including the detected face area in the image, an instruction device which instructs a desired position in the image, and a display control device which displays the individual face display file corresponding to the face area within the selected area when the selected area is instructed by the instruction device.

With the image processing apparatus according to the first aspect, the face area in the image can be individually referred to by instructing the face area using the instruction device such as a mouse or a cross key.

According to a second aspect of the invention, there is provided the image processing apparatus according to the first aspect, wherein the link destination information embedding device creates a clickable map in which the link destination information of the individual face display file corresponding to the face area within the selected area is embedded in the selected area.

With the image processing apparatus according to the second aspect, the clickable map in which the link to the individual face display file is extended in the area including the face area can be automatically created.

According to a third aspect of the invention, there is provided an image processing program for enabling a computer to implement an image input function of inputting an image, an image display function of reproducing and displaying the image, a face area detection function of detecting a face area of a person photographed in the image by analyzing the image, an individual face display file generation function of generating an individual face display file for displaying the trimmed face area by trimming the detected face area, a link destination information acquisition function of acquiring the link destination information indicating a storage location of the individual face display file, a link destination information embedding function of embedding the link destination information for the individual face display file corresponding to the face area within a selected area in the selected area including the detected face area in the image, an instruction function of instructing a desired position in the image, and a display control function of displaying the individual face display file corresponding to the face area within the selected area when the selected area is instructed by the instruction function.

The image processing apparatus of the invention can be realized by applying the software or firmware comprising the image processing program according to the third aspect to a personal computer (PC), a video reproducing apparatus (video deck, television), or the apparatus having an image reproduction function such as a digital camera, a portable information terminal (PDA), or a portable telephone.

With this invention, an image map or the clickable map in which the face area in the image can be individually referred to by instructing the face area using the instruction device such as mouse or cross key can be can be automatically created.

### BRIEF DESCRIPTION OF THE DRAWINGS

FIG. 1 is a block diagram showing a main configuration of an image processing apparatus according to one embodiment of the present invention;

FIG. 2 is a view showing an example of face information;

FIG. 3 is a functional block diagram of the image processing apparatus 10;

FIG. 4 is a view showing an example of image subjected to the image processing;

FIG. 5 is a view showing a part of print order data;

FIG. 6 is a view showing a part of source code for an entire image HTML file (clickable map);

FIGS. 7A and 7B are views showing an example of the individual face HTML file;

FIGS. 8A and 8B are views showing an example of the individual face HTML file;

FIGS. 9A and 9B are views showing an example of the individual face HTML file;

FIG. 10 is a flowchart showing the flow of image processing; and

FIG. 11 is a block diagram showing a main configuration of an image pickup apparatus according to one embodiment of the invention.

### DETAILED DESCRIPTION OF THE PREFERRED EMBODIMENTS

The preferred embodiments of an image processing apparatus and an image processing program according to the present invention will be described below with reference to the accompanying drawings.

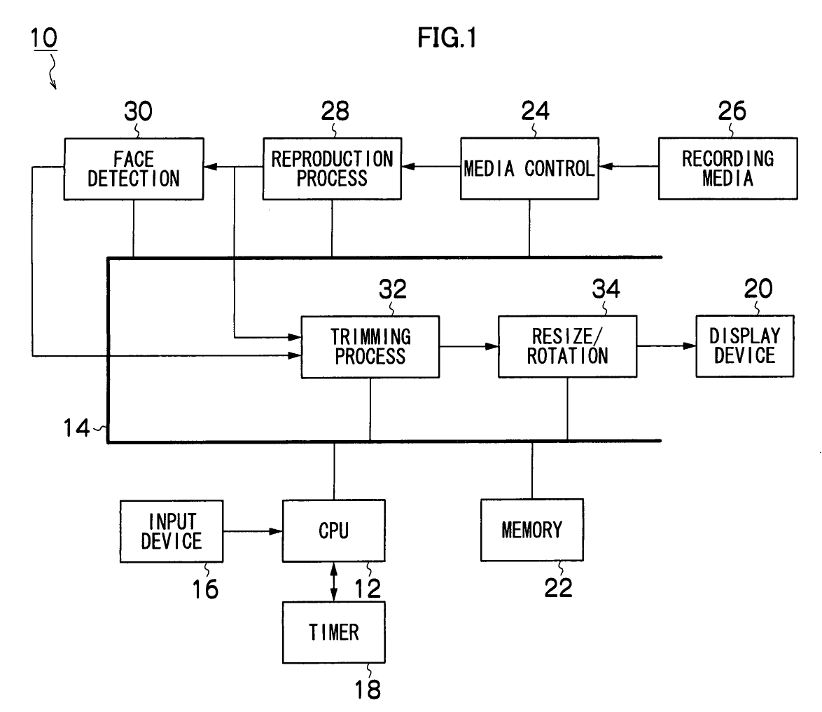

FIG. 1 is a block diagram showing a main configuration of an image processing apparatus according to one embodiment of the invention. In the following explanation, the image processing apparatus 10 of the invention is applied to a personal computer (PC), but may be generally applied to the PC, and the apparatus having an image reproduction function, such as a video reproduction apparatus (video deck, television), a digital camera, a portable information terminal (PDA) or a portable telephone.

In FIG. 1, a CPU (Central Processing Unit) 12 is connected via a bus 14 to each block within the image processing apparatus 10, and a general control part for generally controlling each block based on an operation input from an input device 16. The input device 16 comprises a keyboard, a mouse and other operation members, and outputs a signal according to an operation input from these operation members to the CPU 12. A timer 18 clocks the time.

A display device 20 is a display for displaying the image, various kinds of data and an operation menu, and may be a CRT (Cathode Ray Tube) monitor, an LCD (Liquid Crystal Display) monitor, or an organic electro-luminescence.

A memory 22 comprises a ROM (Read Only Memory) for storing the program processed by the CPU 12 and various kinds of data required for the control, an SDRAM (Synchronous Dynamic Random Access Memory) serving as a working area when the CPU 12 performs various arithmetic operations, and a VRAM (Video Random Access Memory) serving as a storage area for storing the contents displayed on the display device 20.

A media control part 24 is controlled by the CPU 12 to write the data into the recording media 26 or read the data from the recording media 26. The recording media 26 may be any of various media such as a semiconductor memory, a magnetic disk, an optical disk and an optical magnetic disk.

The image read from the recording media 26 is converted into the reproduction image by a reproduction processing part 28, and outputted to the display device 20. A face detection part 30 detects the face area of the person photographed in this image by face recognition technique. Herein, a method for detecting the face area is a well-known technique, and is not described here in detail. An example of the method for detecting the face area includes extracting pixels having a color close to the color specified as the skin color from the original image, and detecting the extracted area as the face area. This process is performed by defining a range of skin color on a color space from the pre-sampled skin color information on the color space for distinguishing the skin color from other colors, and judging whether or not the color of each pixel is within the defined range, for example. Also, extraction of the eyes as face parts is made by detecting an area having lower brightness value than the face area from within the detected face area, for example. Also, extraction of the mouth is made by detecting an area having lower brightness value than the face area in the range lower than both extracted eyes. Also, extraction of the nose is made by designating a schematic area of the nose between eyes and mouth and emphasizing the side edge for this area. And for the obtained image, the brightness value is projected in the transverse direction, and the position having the smallest brightness value is decided as the position of nose.

The face detection part 30 calculates an inclination angle of the face area and a transverse angle by face recognition technique. Herein, the inclination angle of the face area is a parameter representing the inclination of face relative to the top to bottom direction of the image, and calculated based on the inclination of a line connecting both the eyes as detected above relative to the top to bottom direction, for example. Also, the transverse angle is a parameter representing the orientation of the person's face to an image pickup apparatus at the time of photographing (or the angle made between the optical axis direction of the image pickup apparatus and the front face direction of the face), and calculated based on the positions of both eyes and the nose as detected above. For example, if the distance between right eye and nose is shorter than the distance between left eye and nose, it is detected that the person faces in a right oblique direction at the time of photographing.

A trimming processing part 32 performs a trimming process for cutting out a partial area of the image such as the face area as detected above. And this trimmed image is displayed on the display device 20. A resize/rotation processing part 34 enlarges or reduces the partial area of the image trimmed by the trimming processing part 32 and outputs it to the display device 20. Also, the resize/rotation processing part 34 performs a rotation process for the face area, based on the inclination angle of the face area calculated in the above manner.

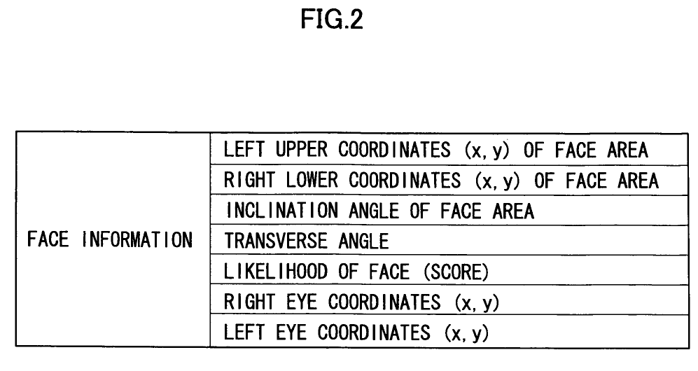

The face information including the face area, its inclination angle and transverse angle calculated in the above manner is stored associated with the image. FIG. 2 is a view showing an example of face information. The face information as shown in FIG. 2 is generated for each face area detected from the image, and written in a header or EXIF (Exchangeable Image File Format) tag of an image data file, for example. This face information may be stored in another file associated with the image data file.

In FIG. 2, the face area is rectangular, and described by the left upper and right lower coordinates, but a description method for the face area is not limited thereto. For example, the face area may be circular or elliptical, with its position described by the central coordinates and the radius, or the lengths of major axis and minor axis. Also, the face area may be polygonal, with its position described by the coordinates of vertices.

Also, the likelihood of face is a parameter representing whether or not the area detected by the face detection part 30 is the face area, and calculated by the degree of skin color, for example. The face detection part 30 calculates the likelihood of this face for every skin-colored area detected from the image, and judges, as the face area, the skin-colored area where the likelihood of face is greater than or equal to a predetermined value.

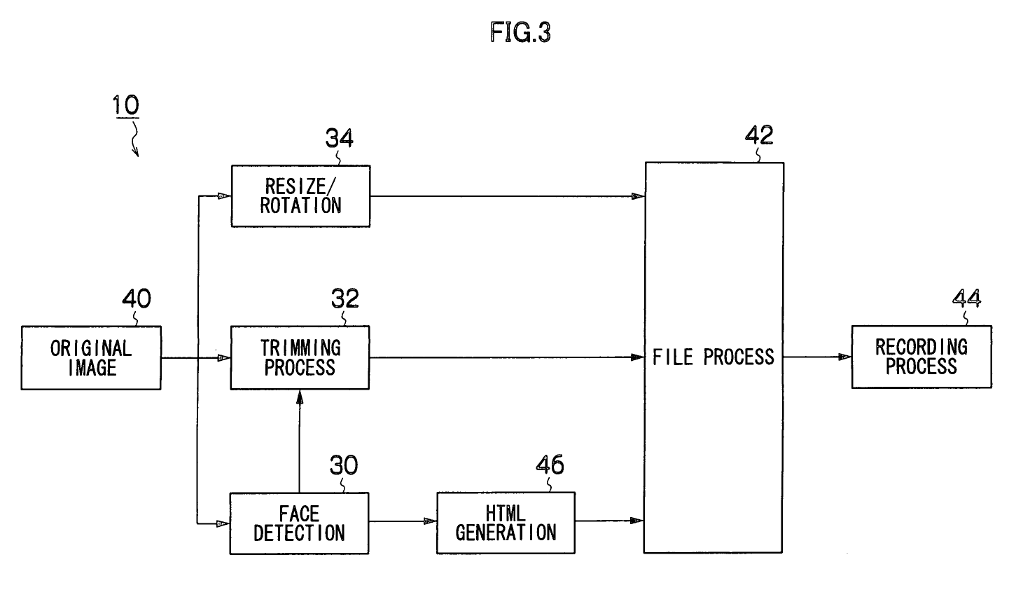

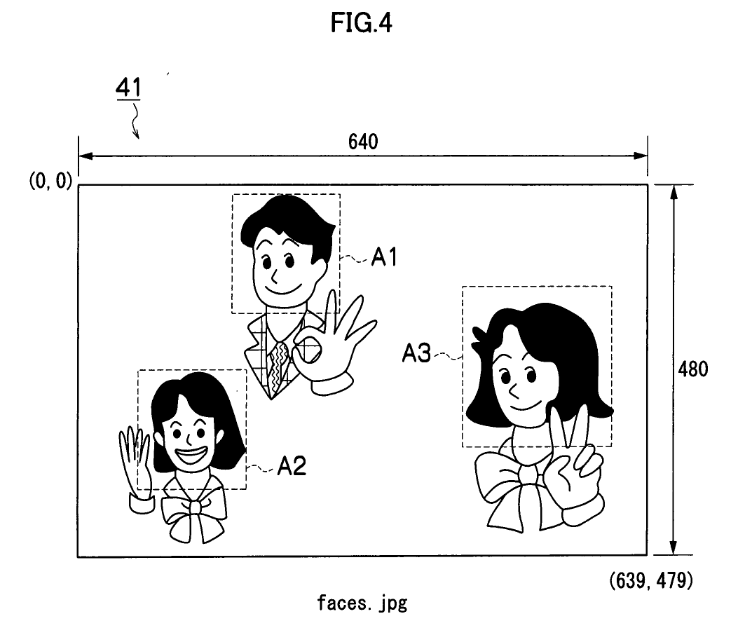

FIG. 3 is a functional block diagram of the image processing apparatus 10, and FIG. 4 is a view showing an example of the image subjected to the image processing. If the image (original image 40) as shown in FIG. 4 is inputted into the image processing apparatus 10, it is resized into a predetermined size by the resize/rotation processing part 34 to generate an entire image file (faces.jpg) 41. Also, the face areas A1 to A3 are detected from the original image 40 by the face detection part 30. The face areas A1 to A3 are rectangular areas specified by the left upper and right lower coordinates, as described above. The number of face areas A1 to A3 is counted by the CPU 12, and the print order data is generated.

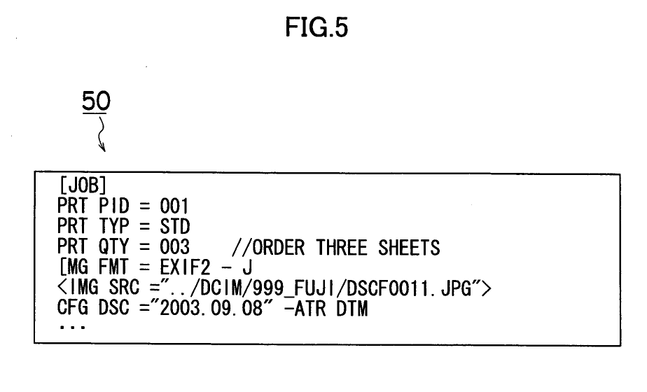

FIG. 5 is a view showing a part of print order data. The print order data 50 as shown in FIG. 5 is a DPOF (Digital Print Order Format) file, including a description that the print order is made by the number (i.e., three) of face areas A1 to A3 within the original image 40. This print order data 50 is associated with the entire image file 41 and recorded in the recording media 26. By employing this print order data 50, the prints by the number of photographed persons can be automatically ordered in making the print order for the entire image file (faces.jpg) 41.

The face areas A1 to A3 as shown in FIG. 4 are trimmed by the trimming processing part 32, and resized into a predetermined size by the resize/rotation processing part 34. If the face areas A1 to A3 are inclined in creating the individual face file, each of the face areas A1 to A3 is corrected for rotation based on its inclination angle. And the individual face file (face1.jpg, face2.jpg, face3.jpg) is generated by a file processing part 42. This individual face file is associated with the original image 40 (e.g., at the same folder) and recorded in the recording media 26 by a recording processing part 44. Thereby, since the entire image file (faces jpg) 41 and the individual face file are associated and stored, the image can be easily processed to be suitable for the management or reproduction display of the image taking notice of the face area of the person photographed in the image.

Then, an individual face HTML file (face1.html, face2.html, face3.html) is created from the individual face file (face1.jpg, face2.jpg, face3.jpg) by an HTML generation processing part 46 as shown in FIG. 3. An entire image HTML file (clickable map faces.html) describing the link destination information (path to the storage destination of each individual face HTML file) for accessing each individual face HTML file at the coordinate positions of the rectangular face areas A1 to A3 detected by the face detection part 30 is generated.

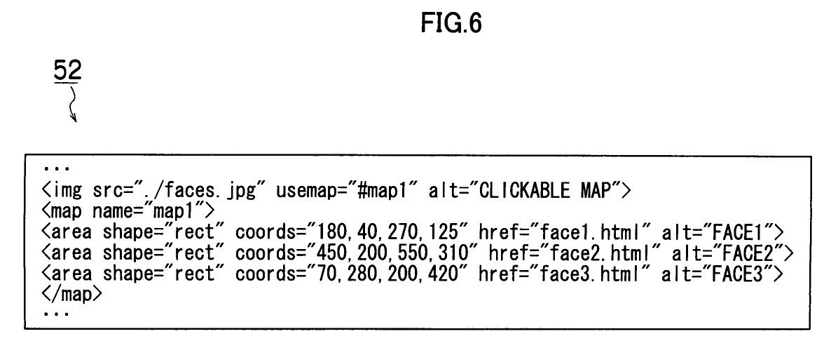

FIG. 6 is a view showing a part of source code for the entire image HTML file (clickable map). As shown in FIG. 6, the link to the individual face HTML file (face1.html, face2.html, face3.html) is extended for each of the face areas A1 to A3 in a clickable map 52. If any of the face areas A1 to A3 is instructed and clicked by a mouse cursor, each individual face HTML file is displayed on the display device 20.

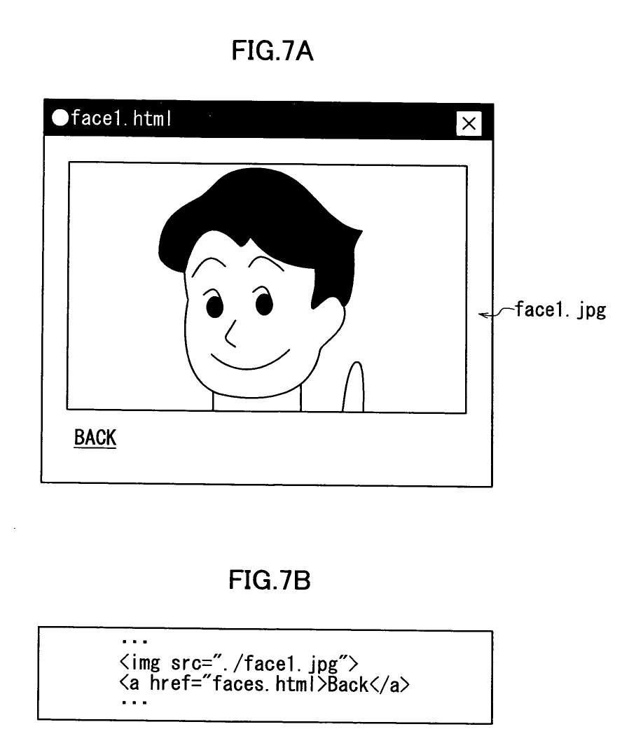

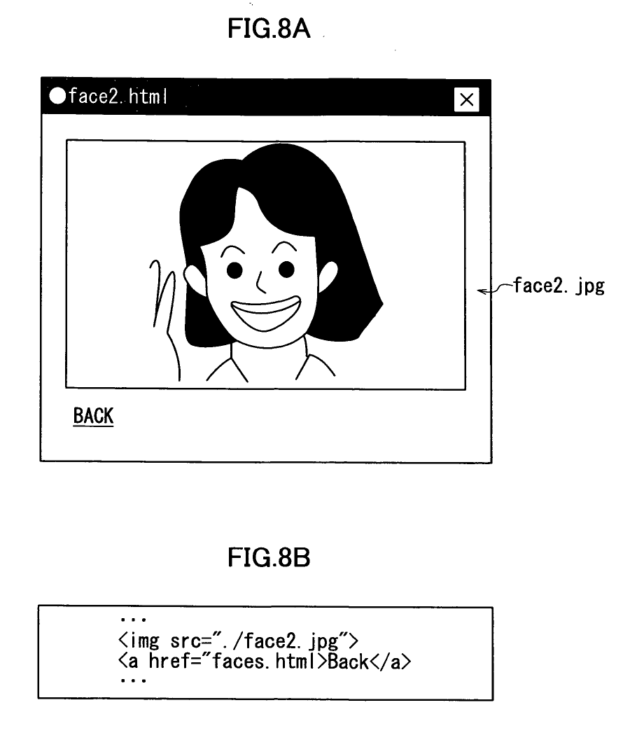

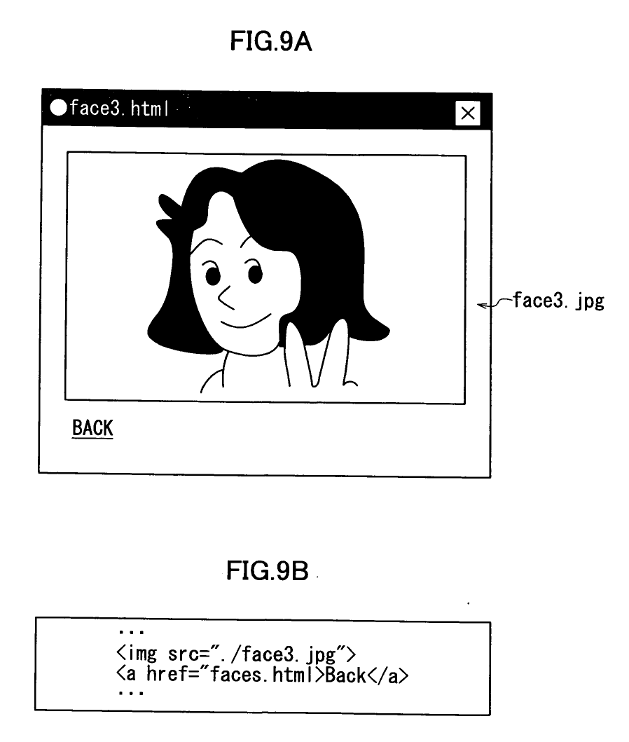

FIGS. 7A to 9B are views showing the examples of the individual face HTML file. FIGS. 7A, 8A and 9A are views showing the display examples of the individual face HTML file, and FIGS. 7B, 8B and 9B are views showing a part of the source code of the individual face HTML file. In FIGS. 7A, 8A and 9A, a text “Back” is linked to the clickable map 52, and if the text “Back” is clicked, the display screen of the clickable map 52 is restored.

In a case where the image processing apparatus 10 has no mouse as the input device 16, if the face area is selected and decided by moving the cursor using an operation member useful to move the cursor, such as a direction key or a cross button, each individual face HTML file is displayed on the display device 20.

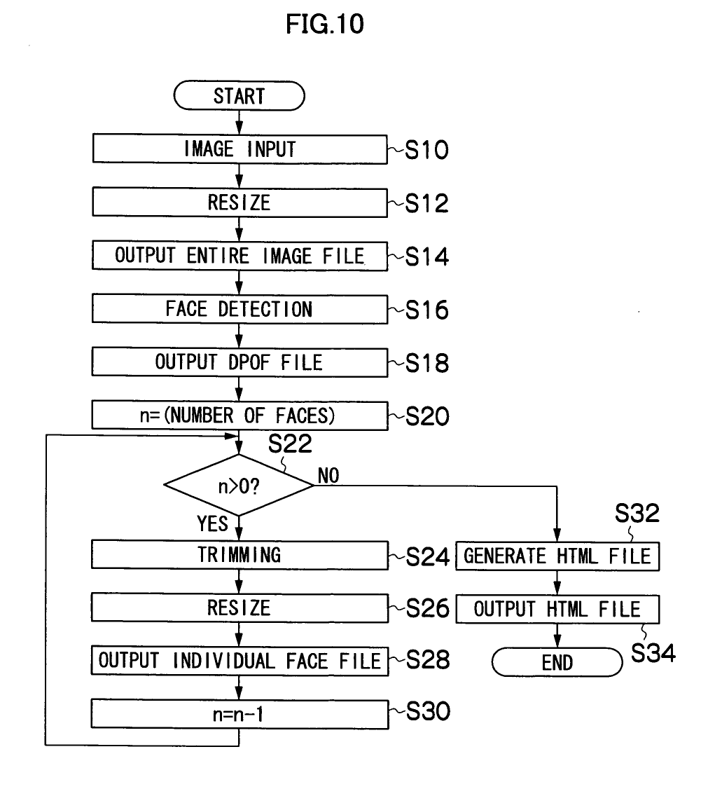

Referring to FIG. 10, the image processing flow of the image processing apparatus 10 according to this embodiment will be described below. FIG. 10 is a flowchart showing the image processing flow. First of all, if an image is inputted (step S10), the input image is resized (step S12), and the entire image file 41 is outputted to the display device 20 (step S14). Herein, the size of the entire image file 41 is transversely 640 pixels×longitudinally 480 pixels, transversely 800 pixels×longitudinally 600 pixels, or transversely 1024 pixels×longitudinally 768 pixels, for example.

Then, the face areas A1 to A3 are detected by the face detection part 30 (step S16), and the number of face areas A1 to A3 is counted. And a screen for accepting an input of the print size is displayed, in which the print order data (DPOF file) for ordering the prints by the number of face areas A1 to A3 (i.e., three) within the entire image file 41 is outputted, and associated with the entire image file 41 and stored in the recording media 26 (step S18). Also, the number of face areas is substituted for the parameter n (step S20).

Then, the face area A1 is trimmed from the entire image file 41 by the trimming processing part 32 (step S24). And this face area A1 is resized in transversely 320 pixels×longitudinally 240 pixels, for example, by the resize/rotation processing part 34 (step S26), and outputted as the individual face file (face1.jpg) (step S28). This individual face file (face1.jpg) is associated with the entire image file 41, and stored at the same folder in the recording media 26 (step S28). And the parameter n representing the number of face areas in which the individual face file is not outputted within the entire image file 41 is decremented by one (step S30). Then, the procedure returns to step S22.

The above steps S22 to S30 are repeated, until the parameter n becomes zero, namely, all the face areas are outputted as the individual face file (No at step S22). Then, the procedure goes to step S32. And the entire image HTML file (clickable map faces.html) 52 and the individual face HTML file (face1.html, face2.html, face3.html) are generated (step S32), and outputted to the recording media 26 (step S34).

With this embodiment, the detection process for the face areas in the entire image file 41 is automatically performed, and the print order data (DPOF file) for ordering the prints by the number of detected face areas is automatically generated. Thereby, the print order by the number of persons photographed in the entire image file 41 is easily made.

Also, with this embodiment, the entire image file 41 and the individual face file in which the face areas A1 to A3 are trimmed are associated and stored. Thereby, the image can be easily processed to be suitable for the management or reproduction display of image taking notice of the face area of the person photographed in the entire image file 41.

Moreover, with this embodiment, the clickable map 52 for referring to the individual face file is automatically created, and the individual faces can be easily referred to from the entire image file 41.

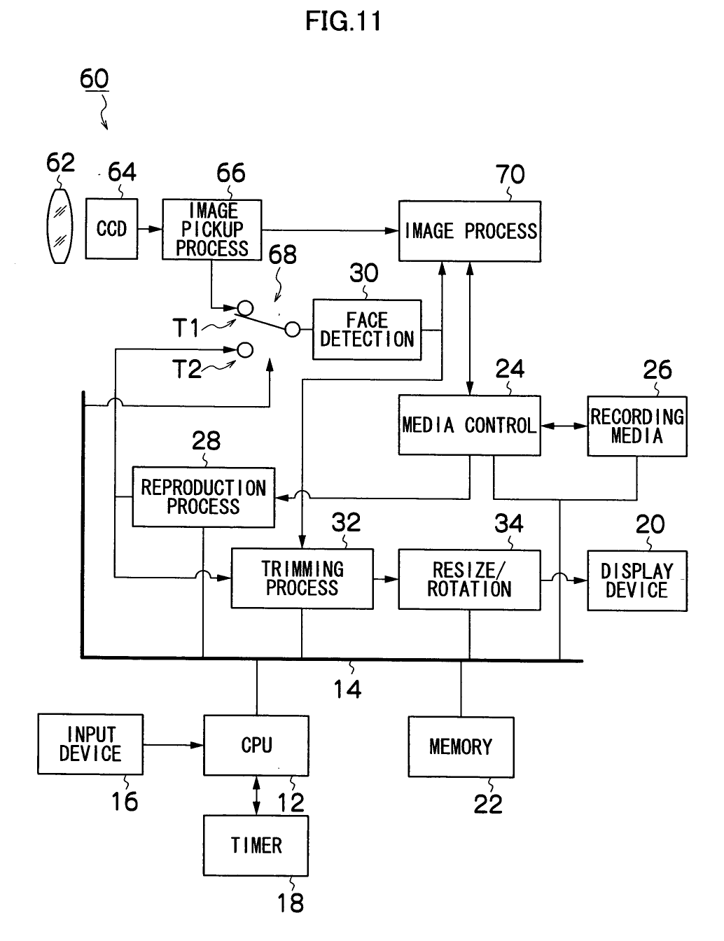

Next, an example of an image pickup apparatus mounting the image processing apparatus 10 of the invention will be described below. FIG. 11 is a block diagram showing a main configuration of the image pickup apparatus according to one embodiment of the invention. In FIG. 11, the image pickup apparatus 60 may be a digital camera or a portable telephone with camera. In FIG. 11, the same parts are designated by the same reference numerals as in the image processing apparatus 10 of FIG. 1, and not described here.

In FIG. 11, the CPU 12 is connected via a bus 14 to each block within the image processing apparatus 10, and a general control part for controlling the operation of the image pickup apparatus 60 based on an operation input from the input device 16. The input device 16 comprises the operation switches such as a power switch, a release switch, and a cross key. The display device 20 is employed as an electronic finder for confirming the angle of view at the time of photographing and for displaying the picked up image data, and may be an LCD monitor, for example.

An image pickup element 64 receives a light coming from an optical system (photographing lens) 62 and converts it into an electrical signal, and may be a CCD (Charge Coupled Device), for example. This electrical signal is amplified by a pre-amplifier, not shown, converted into a digital signal by an A/D converter, not shown, and inputted into an image pickup processing part 66.

The image pickup apparatus 60 of this embodiment has a photographing mode of photographing the image and a plurality of action modes including a reproduction mode of displaying and reproducing the image, whereby the user can set up the action mode by an operation input from the input device 16.

In the photographing mode, the electrical signal outputted from the CCD 64 is processed by the image pickup processing part 66 to create an image (through image) for confirming the angle of view, which is displayed on the display device 20. If the image is taken by operating the release switch, the electrical signal outputted from the CCD 64 by the image pickup processing part 66 is processed to create an image for storage. This image for storage is stored in a predetermined file format (e.g., JPEG (Joint Photographic Experts Group) format) via the media control part 24 in the recording media 26.

Also, in the photographing mode, a switch 68 is connected to terminal T1. And for the image for storage that is processed by the image pickup processing part 66, the face area is detected by the face detection part 30. At this time, the face information (see FIG. 2) acquired by the face detection part 30 is associated with the image for storage and stored in the recording media 26, and the image for storage is processed in accordance with the flowchart of FIG. 10.

That is, the number of face areas detected by the CPU 12 is counted, and the print order data (DPOF file) for ordering the prints by the number of face areas is generated.

As described above, the face area is trimmed by the trimming processing part 32 to generate the individual face file and the HTML file (clickable map), which are associated with the image and stored in the recording media 26.

The trimmed face area may be resized into a thumbnail image, and added to the original image file (e.g., head area of the image file).

On the other hand, in the reproduction mode, the image stored in the recording media 26 by the image pickup processing part 66 is read to create an image for display, which is displayed on the display device 20. In this reproduction mode, the switch 68 is connected to terminal T2, and the process according to the flowchart of FIG. 10 is performed.

Various processes such as a mosaic process for trimming the detected face area and making a mosaic on the face area, an edge emphasizing filter process for the eyes, nose and mouth of the face, and a synthesis process with an effect (template image) may be made by an image processing part 70. Also, the thumbnail image of the face area may be added to the original image file.

The image processing apparatus and the image pickup apparatus of the invention can be realized by applying the software or firmware comprising the program for performing the above-described process to a personal computer (PC), a video reproducing apparatus (video deck, television), or the apparatus having an image reproduction function such as a digital camera, a portable information terminal (PDA) or a portable telephone.

What is claimed is:

1. An image processing apparatus comprising:
an image input device which inputs an image;
an image display device which reproduces and displays the image;
a face area detection device which detects a face area of a person photographed in the image by analyzing the image;
an individual face display file generation device which generates an individual face display file for displaying the trimmed face area by trimming the detected face area;
a link destination information acquisition device which acquires the link destination information indicating a storage location of the individual face display file;
a link destination information embedding device which embeds the link destination information for the individual face display file corresponding to the face area within a selected area in the selected area including the detected face area in the image;
an instruction device which instructs a desired position in the image; and
a display control device which displays the individual face display file corresponding to the face area within the selected area when the selected area is instructed by the instruction device.

2. The image processing apparatus according to claim 1,
wherein the link destination information embedding device creates a clickable map in which the link destination information of the individual face display file corresponding to the face area within the selected area is embedded in the selected area.

3. An image processing program for enabling a computer to implement:
an image input function of inputting an image;
an image display function of reproducing and displaying the image;
a face area detection function of detecting a face area of a person photographed in the image by analyzing the image;
an individual face display file generation function of generating an individual face display file for displaying the trimmed face area by trimming the detected face area;
a link destination information acquisition function of acquiring the link destination information indicating a storage location of the individual face display file;
a link destination information embedding function of embedding the link destination information for the individual face display file corresponding to the face area within a selected area in the selected area including the detected face area in the image;
an instruction function of instructing a desired position in the image; and
a display control function of displaying the individual face display file corresponding to the face area within the selected area when the selected area is instructed by the instruction function.
